(19) United States
(12) Patent Application Publication
(10) Pub. No.: US 2006/0169344 A1
(43) Pub. Date: Aug. 3, 2006

(54) Pipe assembly

(76) Inventor: Kenneth Toole, Skelmersdale (GB)

Correspondence Address: Stephen M. De Klerk;BLAKELY, SOKOLOFF, TAYLOR & ZAFMAN LLP, Seventh Floor, 12400 Wilshire Boulevard, Los Angeles, CA, 90025, US

(21) Appl. No.: 11/250,946

(22) Filed: Oct. 14, 2005

(30) Foreign Application Priority Data
Oct. 14, 2004 (GB) GB 0422782.3

(51) Int. Cl. F16L 9/14

(52) U.S. Cl. 138/149; 138/114; 138/148; 138/109

(57) ABSTRACT

The invention concerns a pipe assembly and a method of constructing it. The assembly comprises an inner pipe 2 and a tubular outer skin 8 which includes polymer material. Settable insulation material 4 is introduced between the inner pipe and the outer skin. In accordance with the invention an interior of the surface is shaped to provide a mechanical key, so that following setting of the insulation material it forms an insulating layer around the inner pipe which is mechanically keyed to the interior surface of the outer skin.

### CROSS-REFERENCE TO RELATED APPLICATIONS

The present patent application claims priority from Great Britain Patent Application No. GB 0422782.3, filed on Oct. 14, 2004.

### BACKGROUND OF THE INVENTION

The present invention relates to pipe assemblies, and in particular, but not exclusively, to underwater pipe assemblies for conveying oil, gas, condensate and other fluids.

When fluids are extracted from an underwater wellhead, it is typically necessary to convey them to a production platform where they can be distributed to, for example, a tanker or into a further pipeline for onward transmission. This is normally achieved by means of a steel riser which extends between a production platform and the wellhead, with a flowline connecting the lower end of the riser to the wellhead.

The fluid which emerges from the wellhead is at an elevated temperature (usually between 80-90 C but sometimes far higher). It is important to maintain the hydrocarbons in the riser at an elevated temperature, since excessive cooling may cause components of it to solidify, resulting in blockage of the riser and loss of production. This can be a significant problem since risers can be of considerable length and they often pass through water which is only a few degrees above freezing point. Such problems are not necessarily unique to undersea risers. Other forms of pipeline, for example overland pipelines, may suffer from similar problems.

It is known to provide fluid-carrying pipes with exterior thermal insulation. The applicant's own published International patent application WO 02/16726 concerns a pipe assembly surrounded by syntactic foam insulation. Such insulation can be moulded in situ upon a metal riser. The process involves placing a section of the metal riser within a mould formed as a tube of polymer material. Spider structures at intervals along the length of this assembly locate the tubular mould relative to the riser. End caps are provided to prevent escape of the moulding material, which is then introduced between the riser and the mould to form an annular insulating layer. The tubular mould, which may be formed from a tough material such as polyethylene, can be left in place upon the pipe assembly to form a durable outer skin. Typically the sections treated in this way can be in the order of 12 meters in length. End portions of the inner metal riser are typically left exposed, beyond the ends of the moulded insulation, to allow the ends of two such riser sections to be welded together. If desired, insulation may be subsequently cast in place over the welded joint.

A problem has now been identified relating to possible slippage of the polymer skin along the length of the pipe assembly. The favoured material, polyethylene, typically forms a poor bond with resin material used in the moulded insulation. The weight of the riser itself, and the consequent tension therein, can be very large indeed. Where the riser is handled through the outer skin, e.g. during its assembly and deployment, there is a consequent risk that the skin will move longitudinally relative to the insulation and the riser within. This is not only undesirable but also potentially dangerous.

### SUMMARY OF THE INVENTION

In accordance with a first aspect of the present invention there is a method of constructing an insulated pipe assembly, comprising:

providing an inner pipe,

providing a tubular outer skin comprising polymer material,

shaping an interior surface of the tubular outer skin to provide a mechanical key,

arranging the tubular outer skin around the inner pipe, and

introducing settable insulation material between the inner pipe and the tubular outer skin,

such that following setting of the insulation material it forms an insulating layer which is mechanically keyed to the interior surface of the outer skin.

The mechanical key between the insulation material and the tubular outer skin is found in practice to prevent slippage of the outer skin.

The shape formed upon the interior surface of the tubular outer skin could in principle take any number of forms. However, it is particularly preferred that it comprises at least one groove, which can conveniently be cut using some form of cutting tool. The groove may be helical, which is convenient where a turning process is used to form it. Preferably the shape comprises helical grooves with opposite angles. That is, one such groove is formed in the manner of a left-hand thread and another is formed in the manner of a right-hand thread. In this way the skin and insulation material are prevented from moving relative to each other in the manner of a screw.

It is particularly preferred that the shaping of the interior surface of the tubular outer skin is carried out using a modified honing tool.

Preferably, a cutting tool is mounted upon a lance which is movable in a direction along the length of the pipe assembly, the cutting tool in use being brought into contact with the inner surface of the outer skin and moved along the pipe assembly by means of the lance whilst either the lance or the pipe assembly is rotated to form a helical groove.

In accordance with a second aspect of the present invention there is a pipe assembly comprising an inner pipe, a tubular outer skin which comprises polymer material and which is arranged around the inner pipe, and a layer of moulded insulation material interposed between the inner pipe and the outer skin, wherein the outer skin has an interior surface which is shaped to provide a mechanical key and which is in intimate engagement with the adjacent surface of the moulded insulation material.

### BRIEF DESCRIPTION OF THE DRAWINGS

A specific embodiment of the present invention will now be described, by way of example only, with reference to the accompanying drawings in which:

FIG. 1 is a section through a pipe assembly embodying the present invention, taken in a radial plane;

FIG. 2 is a section through one wall of the same pipe assembly, taken in an axial plane;

FIG. 3 is a partially sectional view of a pipe assembly embodying the present invention taken in an axial plane, an end-cap used in the moulding process being shown in situ;

FIG. 4 is a section in an axial plane through a tubular outer skin forming part of the same pipe assembly; and

FIG. 5 is a schematic illustration of an arrangement used to shape the interior of the said outer skin.

### DETAILED DESCRIPTION OF THE INVENTION

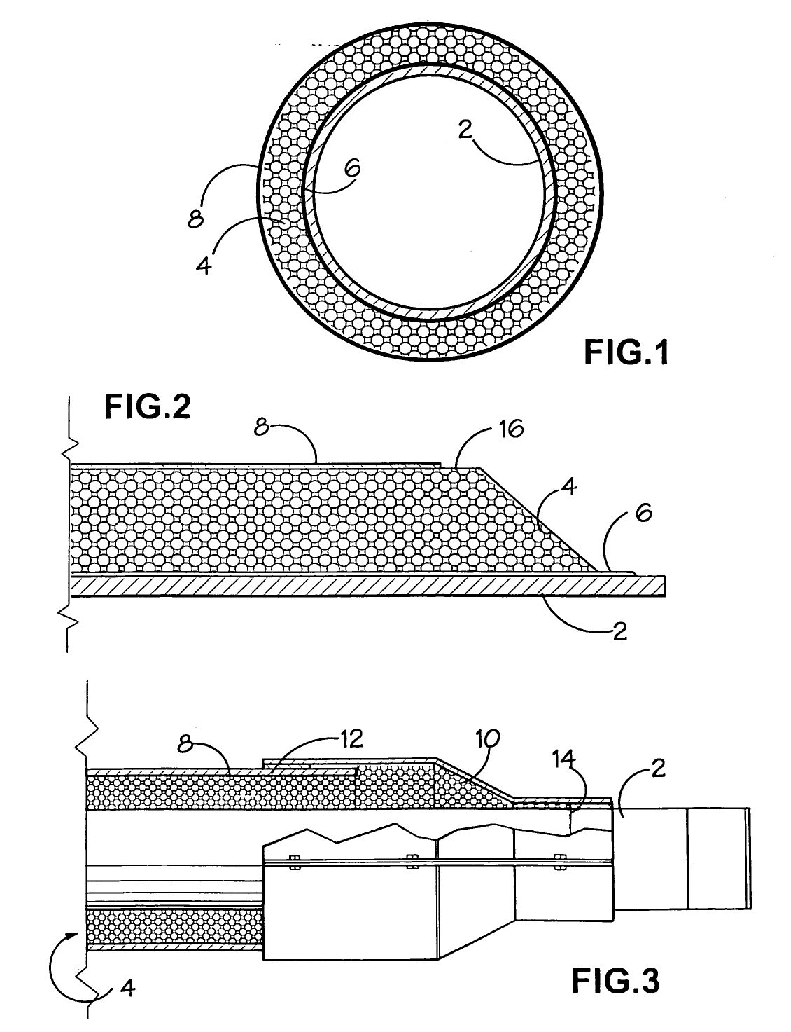

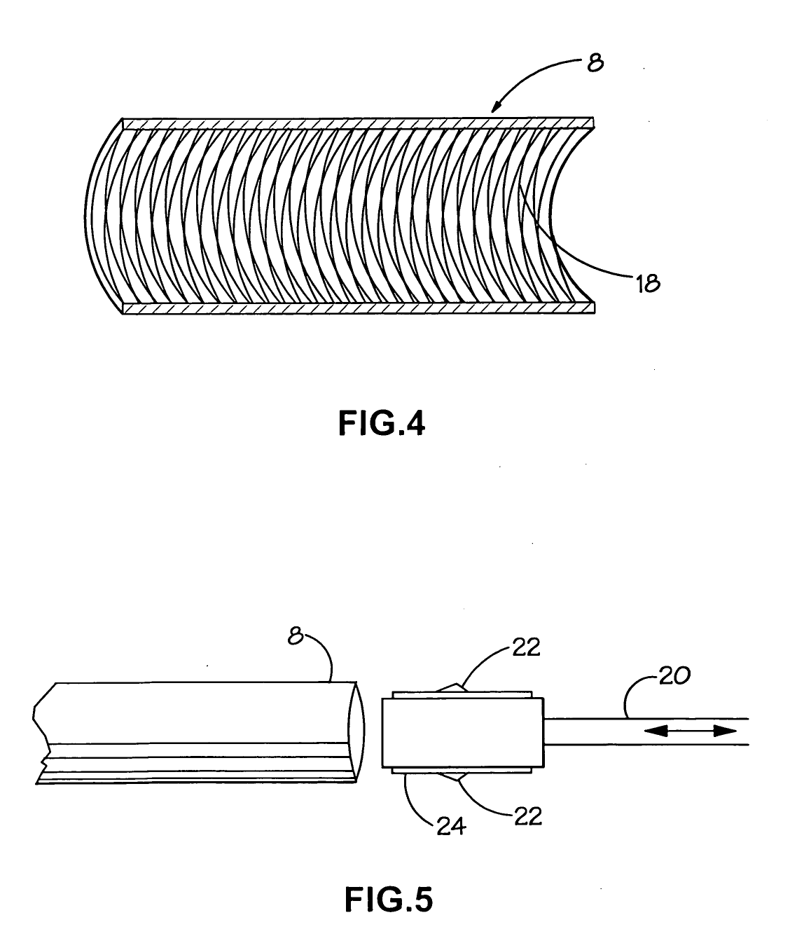

FIGS. 1-3 show a pipe assembly in which a steel riser 2 used for sub-sea hydrocarbon extraction is surrounded by and encased in an annular layer 4 of insulation material. The riser is separated from the insulation material by a conventional fusion-bonded epoxy tie-coat 6. Around the outside of the insulation material 4 is an outer skin 8 which in this embodiment is formed of high density polyethylene (HDPE).

The insulation material 4 is moulded in situ upon the riser 2. In this process the riser 2 is first fitted with spacer structures and then drawn into the outer skin 8, which is of tubular form. The spacers serve to position the outer skin 8 generally concentrically upon the riser 2, so that an approximately annular cavity is formed between them. An end-cap 10 is fitted over the end of the outer skin 8 and has a tapered shape so that it can form a seal with both the outer skin 8 and the riser 2 through respective neoprene collars 12, 14.

The spacers (not seen in the drawings) eventually form part of the layer of insulation material 4 and are in the present embodiment formed of the same polymer material used in forming the insulating layer. For the moulding process itself, the riser 2 is inclined to the horizontal and macrospheres 16 are introduced into the annular volume between the riser 2 and the outer skin 8. In the drawings the macrospheres appear to be regularly arranged, but in this respect the drawings are simplified. In practice a random arrangement is achieved. Macrospheres are in themselves well known to those skilled in the art and are low density spherical bodies, often having a core of expanded polystyrene with a crush resistant outer skin of fibre reinforced plastics. After introduction of the macrospheres 16, the upper end of the mould is sealed using a second end-cap (which is not seen in the drawings but is similarly formed to the first end-cap 10). Moderate heating may be applied. In the present example the mould is heated to a nominal 40° C. Polymer material, in resinous form, is then injected into the annular volume via ports along the length of the outer skin 8. The polymer material used in the present embodiment, comprising polyurethane with an admixture of hollow glass microspheres, is referred to as “glass syntactic polyurethane” or GSPU. The polyurethane used in the present embodiment comprises a polyol blend, which is loaded with the microspheres, and an isocyanate component. Prior to use these components are placed under a vacuum to remove any air that might otherwise contribute to void formation, and are then held in separate heated storage tanks. During processing they are brought together in a mixing head through respective pumping units in the recommended proportions.

It should be understood that other forms of moulded insulation, including other types of syntactic foam could in practice be used. Macrospheres could be dispensed with in applications where density is not critical.

Once the mould is filled, the polymer material is allowed to cure and the end-caps are removed before the pipe is taken from the casting station to cool on a storage rack. The cut backs are trimmed and cleaned of any release agent transferred from the end-caps 10. Quality control inspections are then carried out.

The bond formed between the insulation material 4 and the tie-coat upon the riser 2 is good. Cleaning and mild abrasion of the tie-coat 6 are carried out prior to the moulding process to ensure this. As noted above, however, a good bond cannot be ensured to the outer skin 8.

In order to resist slippage of the outer skin 8 relative to the insulation material 4 within it, a mechanical key is provided on the interior surface of the outer skin 8 prior to the moulding process. It comprises some arrangement of hollows and/or projections to which the moulded insulation material 4 will conform, resulting in intimate mechanical engagement between the adjacent surfaces of the outer skin 8 and the insulation material 4 which resists subsequent displacement of one relative to the other. In the present embodiment, the requisite mechanical key takes the form of helical grooves formed upon the interior surface of the outer skin 8, as seen at 17, 18 in FIG. 4. The illustrated skin has grooves with opposite (and not necessarily equal) pitch angles. That is, one groove 17 is formed in the manner of a left-hand thread and the other 18, in the manner of a left-hand thread.

The groove is formed by a turning process. A cutting tool is inserted into the tubular outer skin 8 and traversed along its length while either the tubular skin or the cutting tool is rotated to form the helical grooves 18. FIG. 5 shows a suitable arrangement in highly schematic form. The cutting head 19 is seen to be mounted upon a longitudinally movable lance 20 aligned with the axis of the tubular outer skin 8 and rotatable thereabout. In this arrangement a set of cutting tools 22, akin to the tooling used in a conventional lathe, is provided and is angularly spaced about the axis of the lance. The tools are mounted upon respective radially movable stubs 24 to allow them to be advanced along the radial direction into cutting contact with the inner surface of the tubular outer skin 8. The multiple tools may be used to form several grooves in the manner of a multi-start thread or, depending upon their longitudinal spacing and the pitch of the thread being cut, they may serve each to deepen a single groove. Cutting of the two oppositely-handed threads 17,18 is achieved simply by first advancing the cutting head 19 and then retracting it, without changing the direction of rotation.

What is claimed:

1. A method of constructing an insulated pipe assembly, comprising:
providing an inner pipe,
providing a tubular outer skin comprising polymer material,
shaping an interior surface of the tubular outer skin to provide a mechanical key,
arranging the tubular outer skin around the inner pipe, and
introducing settable insulation material between the inner pipe and the tubular outer skin,
such that following setting of the insulation material it forms an insulating layer which is mechanically keyed to the interior surface of the outer skin.

2. A method as claimed in claim 1, wherein the tubular outer skin comprises polyethylene.

3. A method as claimed in claim 1, wherein the insulation material comprises syntactic foam.

4. A method as claimed in claim 3, wherein the syntactic foam comprises polyurethane or epoxy.

5. A method as claimed in claim 3, wherein the syntactic foam comprises microspheres and macrospheres.

6. A method as claimed in claim 1, wherein the inner pipe comprises metal.

7. A method as claimed in claim 1, comprising bonding of the insulation material to the inner pipe.

8. A method as claimed in claim 7, comprising pre-treatment of the inner pipe to facilitate bonding of the insulation material thereto.

9. A method as claimed in claim 1, wherein the shaping of the outer skin's inner surface involves forming at least one groove in it.

10. A method as claimed in claim 9, wherein the groove is helical.

11. A method as claimed in claim 10, wherein the shaping process comprises forming two oppositely-angled helical grooves.

12. A method as claimed in claim 10, wherein the groove is formed by means of a cutting tool.

13. A method as claimed in claim 12, wherein the groove is formed by a turning process.

14. A method as claimed in claim 12, wherein the shaping process comprises mounting the cutting tool upon a lance which is movable in a direction along the length of the pipe assembly, bringing the cutting tool into contact with the inner surface of the outer skin, moving the tool along the pipe assembly by means of the lance, and rotating one of the lance and the pipe.

15. A method as claimed in claim 14, wherein it is the lance which is rotated.

16. A method as claimed in claim 15, wherein the cutting tool is moved radially with respect to the lance to bring it into contact with the inner surface of the outer skin.

17. A method as claimed in claim 16, wherein the lance carries a plurality of cutting tools at angular intervals about the lance axis.

18. A method as claimed in claim 1, wherein the pipe assembly forms part of a marine riser.

19. A method as claimed in claim 1, wherein the pipe assembly is for use in hydrocarbon extraction.

20. A pipe assembly comprising an inner pipe, a tubular outer skin which comprises polymer material and which is arranged around the inner pipe, and a layer of moulded insulation material interposed between the inner pipe and the outer skin, wherein the outer skin has an interior surface which is shaped to provide a mechanical key and which is in intimate engagement with the adjacent surface of the moulded insulation material.

21. A pipe assembly as claimed in claim 20, wherein the tubular outer skin comprises polyethylene.

22. A pipe assembly as claimed in claim 20, wherein the insulation material comprises syntactic foam.

23. A pipe assembly as claimed in claim 22, wherein the syntactic foam comprises polyurethane or epoxy.

24. A pipe assembly as claimed in claim 22, wherein the syntactic foam comprises microspheres and macrospheres.

25. A pipe assembly as claimed in claim 20, wherein the inner pipe comprises metal.

26. A pipe assembly as claimed in claim 20, wherein the insulation material is bonded to the inner pipe.

27. A pipe assembly as claimed in claim 20, wherein the inner surface of the outer skin has at least one groove in it.

28. A pipe assembly as claimed in claim 27, wherein the groove is helical.

29. A pipe assembly as claimed in claim 27, comprising at least two helical grooves having opposite pitch angles.

30. A pipe assembly as claimed in claim 20, wherein the pipe assembly is part of a marine user.

31. A pipe assembly as claimed in claim 20, wherein the pipe assembly is used in hydrocarbon extraction.
